(19) United States
(12) Patent Application Publication
(10) Pub. No.: US 2007/0150645 A1
(43) Pub. Date: Jun. 28, 2007

(54) Method, system and apparatus for power loss recovery to enable fast erase time

(75) Inventors: Subramanyam Chandramouli, Folsom, CA (US); Bharat Pathak, Folsom, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/321,327

(22) Filed: Dec. 28, 2005

(51) Int. Cl. G06F 12/00

(52) U.S. Cl. 711/103

(57) ABSTRACT

Data loss or system corruption due to a power loss in non-volatile memory may be prevented by tracking block status information in block headers and/or in a mini-array comprised of non-volatile memory cells. The block status may be tracked and managed during block allocate, deallocate, and erase operations in order to allow the memory to remain coherent if a power failure occurs.

### BACKGROUND

Embodiments of the present invention relate to non-volatile memory devices and more specifically to prevention of data loss or corruption during an erase operation in a block alterable non-volatile memory device, such as flash memory.

Power loss during non-volatile memory operations such as allocate, deallocate, or background reclaim (block erase) operations may result in coincidental data patterns within the memory device. These coincidental data patterns may appear to be legitimate data, but can include invalid data which may cause critical system failures, including software crashes or hangs and potential invalid data presented to the end user. The coincidental data patterns may also cause valid data to become lost or invalid.

### BRIEF DESCRIPTION OF THE DRAWINGS

A better understanding of the present invention can be obtained from the following detailed description in conjunction with the following drawings, in which:

FIG. 1 is a conceptual block diagram illustrating a non-volatile memory device according to one embodiment.

FIG. 2 is a diagram illustrating a block header and a mini-array sector according to one embodiment.

FIG. 3 is a flow diagram illustrating a block allocate algorithm according to one embodiment.

FIG. 4 is a flow diagram illustrating a block deallocate algorithm according to one embodiment.

FIG. 5 is a flow diagram illustrating a background erase according to one embodiment.

FIG. 6 is a system block diagram illustrating a non-volatile memory device in a system according to one embodiment.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern algorithms and circuits to prevent data loss or system corruption due to power loss in non-volatile memory. Although the following discussion centers on flash memory it will be understood by those skilled in the art that the present invention as hereinafter claimed may be practiced in support of any type of memory, including non-volatile memory.

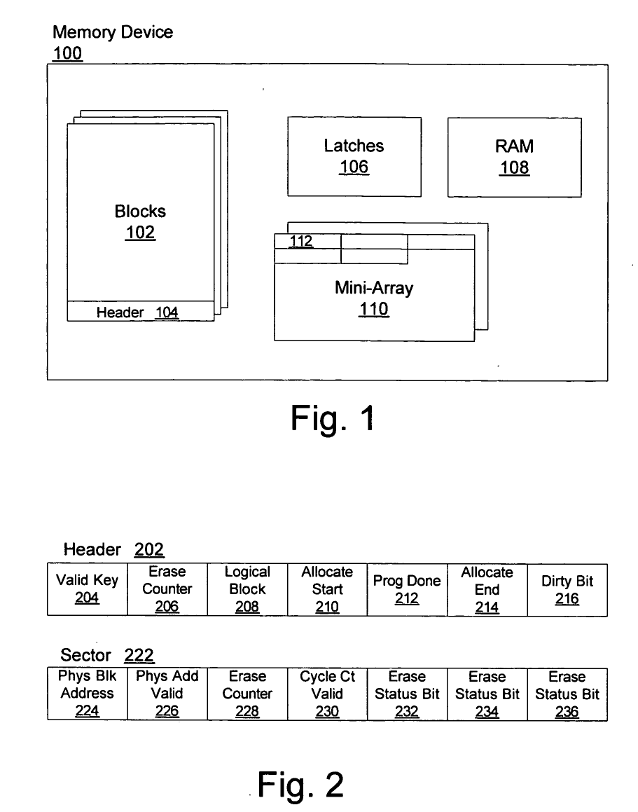

FIG. 1 illustrates a memory device according to one embodiment. The memory device is comprised of blocks (102) which may store user data or control information. The blocks may be programmed, read, or erased. When a user issues a program command, one or more blocks may be allocated from a pool of available blocks. When a user issues an erase command, one or more blocks may be deallocated, and a background erase is performed. The deallocate and background erase operations provide fast erase times from a user's perspective, because the user will be able to perform other operations in the memory device very quickly after the block has been deallocated, while the actual erase is completed in the background.

Each block (102) includes an associated block header (104). The header is unique to each block and may be used to store state information to identify the state of the block at any given time. By tracking the state of the block in a block header, the device can recover from a power loss in a manner which allows the memory to remain coherent. In some embodiments, the header may be implemented as a row within the block. The row may not be directly accessible to the user, and may be visible and accessible only internally by the device itself. The contents of the header are discussed in more detail in conjunction with FIG. 2, below.

In other embodiments, the header for a block may be stored outside of the block itself. For example, block headers for all blocks may be stored in a single block dedicated to block header storage, or may be stored in a separate area of memory.

The device also includes a mini-array (110). The mini-array is a group of individually erasable cells that are unrelated to any blocks in the device. The mini-array may be divided up into smaller portions, or sectors (112) of a predetermined length. Each sector may be used to store power loss recovery information during a block erase. In one embodiment, jump tables may be maintained as fields within the mini-array in order to optimize the background reclaim time. The contents of the mini-array sectors are described in more detail in conjunction with FIG. 2, below.

The size of the mini-array may be chosen such that the device's block swapping feature is optimized, and can be determined based on the performance requirements of the memory device. In one embodiment, the device may contain two or more mini-arrays (110). This allows the mini-arrays to be swapped with one another so that a mini-array that is full and has no remaining available sectors may be erased while another mini-array having available sectors is in use.

The device (100) may also include latches (106) and Random Access Memory (RAM) (108). The latches (106) may be used to save block status and/or logical/physical block mapping information in a manner that is easily and quickly accessible. The RAM (108) may be used to store control information and/or file management software.

FIG. 2 illustrates an example of a block header and a sector according to one embodiment. The block header and sector may each include more or less information than that illustrated in the example of FIG. 2. The block header (202) may include one or more of the following items: a valid key (204), an erase cycle counter (206), logical block number (208), allocate start indicator (210), program done indicator (212), allocate end indicator (214), and dirty bit (216).

The valid key (204) includes one or more bits to indicate the status of the block. The status of the valid key determines whether the block is in the pool of available blocks to be allocated or whether the block is in use or otherwise unavailable for allocation.

The erase cycle counter (206) tracks the number of time the block has been erased. This data may be used to allocate blocks so that erase cycles are distributed as evenly as possible across all blocks in the device. The erase counter may also be used to detect when a block has reached a predetermined erase cycle threshold limit. This information may be used to make sure that blocks are evenly cycled in the device.

The logical block number (208) stores the logical block number that is assigned to the physical block upon block allocation.

The allocate start bit(s) (210) indicate that a block allocate operation has begun. Similarly, the allocate end bit(s) (214) indicate that a block allocate operation has successfully completed. The program done bit(s) (212) indicate that the logical block number (208) has been successfully programmed into the block header. These three fields may be used to detect whether a power loss has occurred during the allocate process and at what point during the allocate algorithm the power loss occurred. If a power loss has occurred, the data in these fields may allow steps to be taken to recover from the power loss.

The dirty bit (216) indicates whether the block has been deallocated by the user. If the block has been deallocated, the dirty bit is set, and the block is removed from the block mapping scheme so that a background erase operation may be performed on the deallocated block.

A mini-array sector (222) may include one or more of the following items: a physical block address (224), physical address valid indicator (226), erase cycle counter (228), erase cycle count valid indicator (230), and one or more erase status bits (232, 234, 236).

The physical block address (224) indicates the physical block associated with the sector (222). The physical address valid bit(s) (226) indicate whether the physical block address (224) was successfully programmed to the mini-array sector (222). This information may be used during power loss recovery.

The erase cycle counter (228) is used to store an incremented copy of the block header's erase cycle counter (206). After a block's incremented erase cycle count has been successfully written to the mini-array sector, the cycle count valid bit(s) (230) are programmed to indicate that the sector contains a valid cycle count for the associated physical block, which will be erased in the background shortly.

One or more erase status indicators may also be included in the mini-array sector (232, 234, 236). These erase status indicators track particular events during the block erase process, and are used for power loss recovery purposes. For example, one or more bits in the sector may be used to indicate whether an erase operation has successfully completed or whether the erase has been verified.

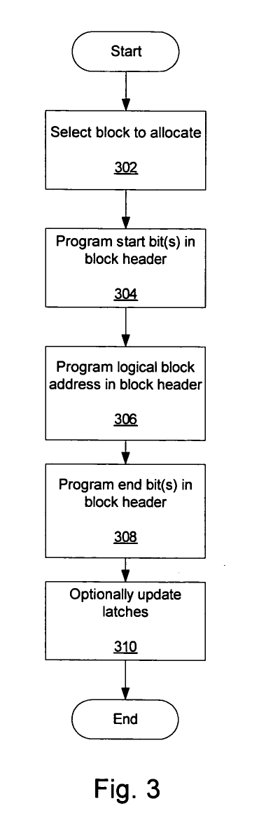

FIG. 3 is a flow diagram which illustrates a block allocate operation according to one embodiment. Before a user can program a block, a block allocate request must be issued in order for a block to be made available at the user specified logical address location. The memory device may internally select a block to allocate (302) using a block allocation algorithm. In one embodiment, the allocation algorithm may take the block's erase cycle count into consideration when determining which block to allocate. The selected block will be mapped or allocated to the user requested logical address.

After the block to allocate has been selected, the allocate start bit(s) are programmed in the block header (304). Next, the logical block address specified by the user is programmed in the block header (306). This allows the logical block address to be mapped to the physical block that is being allocated. After the logical block address has been successfully programmed in the header, a program done bit may programmed. Next, the allocate end bits(s) are programmed in the block header (308). If the device includes mapping latches to map logical block addresses to physical block addresses, these latches may optionally be updated to reflect the logical block address of the newly allocated physical block (310).

After the allocation operation has completed, the user may use the newly allocated block for regular memory operations. On power up, the internal block headers are read internally to determine the state of each block. By reading the block headers, it can be determined whether power loss occurred during the allocation process. For example, if the allocate start bit is set in the header but the allocate end bit has not been set, then a power loss occurred during the allocate operation. In this case, the block may be returned to the dirty pool, or may be dispositioned in another manner.

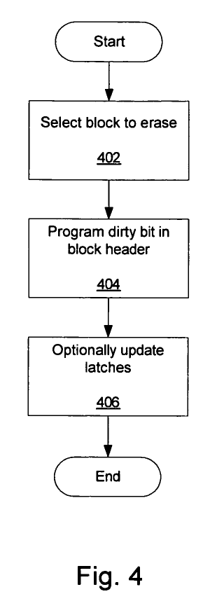

FIG. 4 illustrates a deallocate operation according to one embodiment. The user selects a block to be erased (402). This may be done by providing a logical address that is translated by the device to a physical block location. In one embodiment, this translation may be done using a mapping table. A dirty bit is then programmed in the physical block's block header (404). The dirty bit indicates that the block is no longer in use, and that it may be erased during a subsequent background erase operation. Finally, mapping latches may optionally be updated to disassociate the logical block address from the physical block (406).

Once a block has been deallocated, the user may issue an allocate command to the same logical block address almost immediately and begin using the logical block now associated with a new physical block while the previous physical block is undergoing a background erase. This allows for fast block erase times.

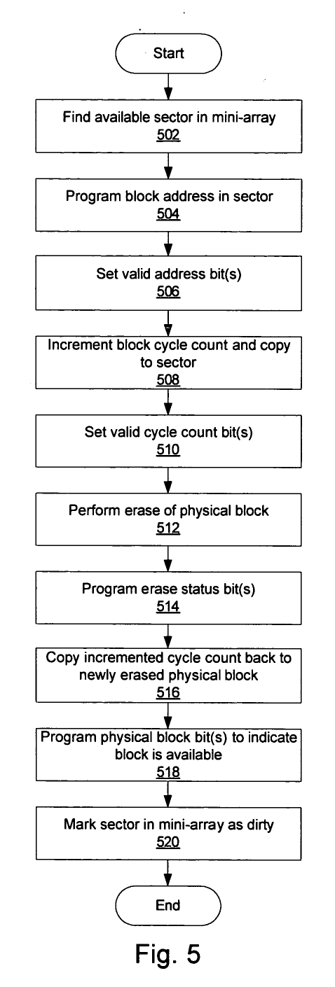

FIG. 5 is a flow diagram illustrating a background erase operation. A background erase operation may be performed on a block after it has been deallocated. In one embodiment, a deallocated block is indicated by a set dirty bit in the block's header.

If power is lost during a background erase, it is important to identify which block was being erased during the power loss. In one embodiment, a mini-array may be used to store data related to the erase process in order to identify the block being erased and to protect other critical block information during an erase cycle.

When a block erase is performed, an available sector in the mini-array is identified (502). In one embodiment, an available sector may be identified by scanning a portion of the sector to determine whether the sector is available or not. For example, the first one or more bits of a sector may store a jump table to determine which is the next available sector that can be used.

When an available sector has been identified, the physical block address is programmed into the sector (504). This allows a particular physical block to be identified if a power loss occurs during erase of that block. All other information stored in the sector will be associated with this physical block address.

After the physical block address has been successfully written to the sector, one or more bits is set indicating that the physical block address has successfully been written to the sector and is valid (506).

Next, the block's erase cycle count from the block header is incremented and copied to the sector (508). This allows the erase count to be incremented and securely stored each time the block is erased in order to track the total number of times a particular block has been erased. After the cycle count has been successfully written to the mini-array sector, one or more bits may be set indicating that the erase cycle count is valid (510). In other embodiments, the block's erase cycle count may be copied to the sector and incremented later, for example, at the time the erase cycle count is copied back to the block.

After the incremented erase cycle count and any other desired information has been copied from the block header and stored in the mini-array sector, the erase of the physical block may be performed (512). After the erase is completed, one or more erase status bits may be set (514). These bits may indicate that the block erase has successfully completed, that an erase verification has been completed, or may indicate that other erase-related operations have been performed on the block. Additionally, other progress bits may be programmed to mark important milestones during the erase process.

When the block erase has successfully completed, the incremented cycle count may be copied from the mini-array sector back to the newly erased physical block header (516). One or more bits in the newly erased block's header may also be programmed to indicate that the block is now available to be allocated (518). For example, header bits for a Valid Key may be programmed to indicate block availability.

Finally, when the erase is complete and all necessary data has been copied from the mini-array sector to the block header, the sector in the mini-array may be marked as dirty (520). In one embodiment, when all sectors in the mini-array have been marked as dirty, the mini-array may be swapped with a second mini-array and erased to create free sectors. In another embodiment, individual sectors within a single mini-array may be erased as needed to provide free sectors.

If power is lost at any point during the above described block erase algorithm, it is possible to recover from the power loss completely without impacting the system. Copies of critical information are stored in the mini-array during the block erase, and status bits indicate the progress of the erase algorithm at each point. Note that while only a few types of status bits are described herein, both the block header and the mini-array may be used to store additional states that can mark different portions within the main erase algorithm. This may save time in a subsequent erase if a power loss were to occur during an erase cycle.

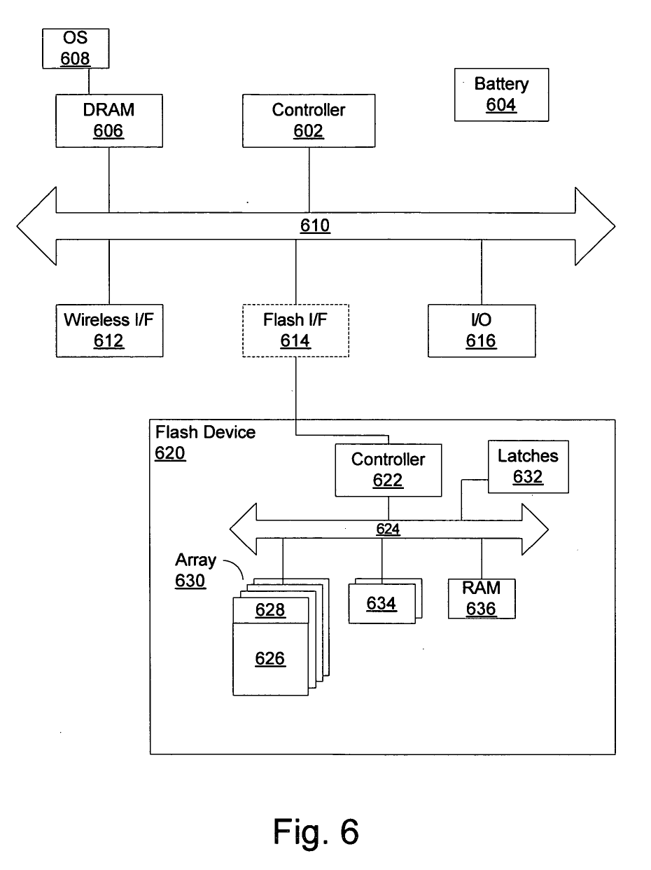

FIG. 6 is a block diagram of a system according to one embodiment. The system may include a controller (602) which communicates via a bus (610). The controller (602) may be a microcontroller, one or more microprocessors, a digital signal processor (DSP), or another type of controller. The system may be powered by a battery (604) or may be powered with another power source, such as AC power.

System memory or dynamic random access memory (DRAM) (606) may be coupled to the bus (610). The DRAM (606) may store an operating system (OS) (608) after system initialization.

A variety of input/output (I/O) devices (616) may be coupled to the bus (610). The I/O devices may include items such as a display, keyboard, mouse, touch screen, or other I/O devices. A wireless interface (612) may also be coupled to the bus (610). The wireless interface (612) may enable cellular or other wireless communication between the system and other devices. In one embodiment, the wireless interface (612) may include a dipole antenna.

The system also includes a non-volatile memory device (620), such as a flash memory device. The memory device may be built into the system, or may be part of a removable storage medium, such as a card form factor, that may be inserted into an optional flash card interface or other type of interface.

The memory device (620) may include a controller (622) coupled by a bus (624) to an array (630), a mini-array (634), latches (632), and a small random access memory (RAM) (636). The array (630) is comprised of a plurality of blocks (626), each having a block header (628). The block header may be used to store state information to identify the state of the block at any given time, as described above in conjunction with FIG. 2.

The memory device also includes one or more mini-arrays (634). A mini-array may be comprised of a group of individually erasable cells that are unrelated to any block (626) in the device. The mini-array is described in more detail in conjunction with FIG. 2, above.

The block headers (628) and the mini-array(s) (634) store power loss recovery information to enable the system to recover from any power loss that may occur during a block allocate, deallocate, or background erase operation. For example, if the battery (604) or other power source fails after an allocate command has been issued to the memory device (620) by a user via the system controller (602), the memory device (620) will be able to use the information stored in the block header(s) (628) and mini-array (630) to recover from the power failure.

Latches (632) may be used to store information mapping logical block number to physical block number. Latches (632) may optionally be used to store additional power loss recovery information or other block status information.

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method, apparatus, and system for power loss recovery in a non-volatile memory device are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
selecting a block of memory to allocate;
writing a first value to a block header to indicate the start of a block allocate operation;
writing a logical block address for the block of memory to the block header; and
writing a second value to the block header to indicate the end of the block allocate operation.

2. The method of claim 1, wherein the block of memory is a block of flash memory.

3. The method of claim 1, wherein the block header is a hidden row within the block of memory.

4. The method of claim 1, further comprising updating a set of latches to associate a physical block address with the logical block address.

5. The method of claim 4, further comprising writing a third value to the block header to indicate that the block of memory is dirty.

6. The method of claim 5, further comprising updating the set of latches to disassociate the physical block address from the logical block address.

7. The method of claim 1, further comprising performing a power on operation and reading the block header to determine if a power loss has occurred.

8. A method, comprising:
selecting a block to erase, wherein the block has a physical block address and a cycle count;
finding an available sector within a mini-array;
programming a start physical address write value to the sector;
writing the physical block address to the sector;
programming an end physical address write value to the sector;
incrementing the cycle count by one and writing an incremented cycle count to the sector;
programming a start erase value to the sector;
erasing the block to create an available physical block;
programming an end erase value to the sector; and
copying the incremented cycle count from the sector to a header associated with the available physical block.

9. The method of claim 8, further comprising programming erase progress bits to indicate erase milestones.

10. The method of claim 8, further comprising updating a set of latches to disassociate the physical block address from a logical block address.

11. The method of claim 8, further comprising performing a power on operation and reading the sector to determine if a power loss has occurred.

12. The method of claim 8, wherein the mini-array is an array of non-volatile memory cells.

13. A memory device comprising:
a controller;
a plurality of blocks coupled to the controller, each block associated with a block header to store an erase cycle count, a logical block number, and erase status information; and
a first mini-array of non-volatile memory cells coupled to the controller, the mini-array to store information during a block erase cycle.

14. The memory device of claim 13, further comprising a second mini-array of non-volatile memory cells.

15. The memory device of claim 13, wherein each block header comprises a row within one of the plurality of blocks.

16. The memory device of claim 13, wherein the first mini-array is organized in sectors of predetermined length.

17. The memory device of claim 13, wherein the first mini-array includes jump table fields.

18. A system comprising:
a bus;
a processor coupled to the bus;
a wireless interface coupled to the bus; and
a flash memory device coupled to the bus, wherein the flash memory device includes a block having an associated block header to store erase cycle count information, a logical block number, and power loss recovery information.

19. The system of claim 18, wherein the power loss recovery information includes at least a block allocate start indicator, a block allocate end indicator, and a dirty block indicator.

20. The system of claim 18, wherein the flash memory device further includes a mini-array to store erase status information.

21. The system of claim 20, wherein the flash memory device further includes a plurality of latches to store a mapping table.

22. An article of manufacture comprising a machine-accessible medium having stored thereon instructions which, when executed by a machine, cause the machine to:
write a block allocate start value to a block header associated with a block of memory;
allocate the block of memory; and
write a block allocate end value to the block header.

23. The article of manufacture of claim 22, wherein the instructions, when executed by the machine, further cause the machine to write a third value to the block header to indicate that the block of memory is dirty.

24. The article of manufacture of claim 23, wherein the instructions, when executed by the machine, further cause the machine to read the block header to determine if a power loss has occurred.

25. The article of manufacture of claim 22, wherein the instructions, when executed by the machine, further cause the machine to:
find an available sector within a mini-array; program a start physical address write value to the sector;
write a physical block address to the sector;
program an end physical address write value to the sector;
write an incremented cycle count to the sector;
erase the block of memory;
program at least one erase status value to the sector; and
copy the incremented cycle count to the block header after the block erase is complete.

26. The article of manufacture of claim 25, wherein the instructions, when executed by the machine, further cause the machine to read the sector to determine if a power loss has occurred.
